(19) United States
(12) Patent Application Publication
(10) Pub. No.: US 2003/0154141 A1
(43) Pub. Date: Aug. 14, 2003

(54) Image recognition inventory management system

(75) Inventors: Mario Capazario, Geneva (CH); Jeffrey Rubin, Richmond (AU)

Correspondence Address: DARBY & DARBY P.C., P. O. BOX 5257, NEW YORK, NY, 10150-5257, US

(73) Assignee: Pro Corp Holdings International Ltd.

(21) Appl. No.: 10/246,384

(22) Filed: Sep. 18, 2002

Related U.S. Application Data
(60) Provisional application No. 60/323,397, filed on Sep. 18, 2001.

(51) Int. Cl. G06F 17/60

(52) U.S. Cl. 705/27

(57) ABSTRACT

A method and system that includes a microprocessor device with memory adapted to receive input corresponding to a report at an instant of time of an amount of product in a product display in a business, and further adapted to store the data in the memory. The method and system also include a central computer for receiving and processing the data from the microprocessor device so that the computer is configured to create a planogram which optimizes the display of the product by maximizing the amount of desired product and minimizes the amount of undesired product to be displayed. The central computer further contacts product suppliers so that the quantity of supplied product always meets the requirements of the planogram.

### CROSS REFERENCE TO RELATED APPLICATIONS

This application claims the benefit of U.S. Provisional Patent Application No. 60/323,397, which is hereby incorporated in its entirety.

### FIELD OF THE INVENTION

This invention relates to the field of shelving, computerized inventory management, delivery and, more specifically, to the field of optimizing the relationship between product quantities and product displays in retail business, including marketing. The present system is configured to maximize the sale of products and minimize waste and allow stock management to be done in a number of different locations.

### BACKGROUND

Products are often displayed in a store based on historical data, e.g., sales data. This historical data consists of information ascertained at the point of sale and from periodic inventorying. From such data, store managers attempt to evaluate consumer interest in a product. Based on an accumulation of data from a given chain of stores, the regional manager calculates how much of a product was sold and divides this total by the number of stores in the region, resulting in sales data and product allocation based on one per store average within the region.

The current practices have certain deficiencies. For example, the above approach results in distributing goods evenly over a chain, whether or not the goods accommodate local demographics. Moreover, calculating a total amount of sales over a given day does not account for whether or not enough of that product was available for customer purchase at a peak time. If at one o'clock in the afternoon on a Saturday more milk is normally sold than at any other point during that day, then it is more fiscally prudent to accommodate for the peak sale period rather than attempting to uniformly supply the milk over the entire day. Further, overstocking of undesirable goods and allotting too much display space to these goods decreases the ability to maximize the display of the desirable goods, causing lost sales and lost revenue.

Current inventory practices are also inefficient. Most inventory management requires personnel in every store to make the reports. Clerks typically total the amount of the product on paper, and this data is entered into a spreadsheet or database. These paper reports are common in the industry and are usually completed on paper and then inputted at the end of a shift. This significantly delays availability of relevant information. Also, this repetition of recording the data is time consuming and prone to errors due to the duplication of effort and in addition, clerks charged with sales and stocking may also be responsible for completing inventories and reporting problems, which may lead to conflicts with reporting data honestly. Lastly, because of such delays, it is difficult for the information to be used the same day and the national office does not have real time access to any one store's inventory and shelf stock.

Other product display and ordering systems take demographic information into account. Each individual store is required to understand the type of customers within its area. This information would include age, race, sex, religion, earnings, etc. From this profile, general purchasing habits are assumed and the stores will display and order accordingly. This type of system requires research into the surrounding area and is usually static. Also, display and ordering practices are based primarily on assumptions and not actual purchasing habits.

Retail food stores, in particular, rely on spot checks and sales numbers generated at the checkout counter to determine their ordering and inventory. Normal spot checks are used just to see if the display is dirty or disorganized or under stocked. However, the system is far from accurate and only tracks what is sold, not the entire selling potential of any given item. These problems are magnified for perishable items. These items need to be kept constantly clean and properly rotated to assure maximum sales and minimize waste due to items being outdated.

Another aspect of this invention is that fact that 20% of most milk deliveries in major metropolitan areas are “route” deliveries. A route delivery means that a store does not put in an actual delivery order. A truck is stocked at the beginning of the day with a fixed amount of goods, and typically the stocking of the truck involves a degree of guesswork and personal experience. The truck then goes along its route and the store owners order whatever they need in view of the inventory stocked in the truck. If an item sells out, all other stores later in the route cannot purchase that product, regardless of their stocking needs. This procedure is inefficient since the truck can be stocked with product that no store needs and/or can be under stocked in the ones that are needed. However, this procedure is used due to the very large volume of processing that would be required if every deli and convenience store in a metropolitan area called in daily orders.

Effective retail marketing requires a system that can determine the exact amount of product that should be provided to customers at a peak time of a day or over a predetermined time period. What is also needed is a system that can discern which products are over stocked (relatively undesirable goods) and which are under stocked (relatively desirable goods) at a peak period of a day or over a period of time so as to further optimize displays and, therefore, revenue. Moreover, there is a need for a system that can perform such calculations for every store within a regional chain of stores, rather than focusing on the total sale within a given region, so that specific local interests can be taken into account. There is a further need for a system that does not require knowledge of the demographics of the surrounding areas and is based on historical assumptions. Also, it is desirable to provide a system that can transmit real time data to any person who requires real time information about the status of the store's inventory regardless of the location of this person.

Certain systems have already been developed that perform some of these tasks. European Patent Application Number 99303314.1 to Ashton describes a shelving system to detect the presence of items on a particular shelf. The system requires specialized shelves designed to detect radio frequency identification tags. This system can then determine the presence and location of a tagged item on the shelf and relay this information to a computer system for inventory management and product ordering. However, these systems are expensive to install as compared to standard shelves and are difficult to retrofit into an existing store, since both require entire shelves to be emptied, replaced and restocked quickly so to minimize disruption to the shoppers and regain the retail space. Additionally, every product must be radio tagged for the system to function properly. This tagging must conform to an industry wide standard. Currently, most products are not radio tagged so either the distributor or the store owner must tag the products. The tags will add additional costs in purchasing the tags and tagging the items. Even if the manufacturer begins to tag their product, the manufacturer will pass along the costs associated with tagging the product in the cost of the product. Lastly, Asthon's system only tracks the inventory, it does not link the data gathered to an inventory management system to optimize the placement of goods on the shelves.

### SUMMARY

The key feature of the present system is the ability to update a store's inventory and planogram as required to keep the most saleable items in stock and on the shelves at all times. There are a number of methods to perform this task.

According to one embodiment, the system utilizes video recognition technology and includes video cameras posted above every isle to transmit data for the products on display, including quality and quantity. The cameras will be linked to software that will recognize which product is low and missing and request an order and/or update the planogram according to the stock and inventory on hand and on order. Due to the nature of the system, the image can be transmitted to any computer via a Local Area Network (LAN) or Wide Area Network (WAN) and then the ordering and restocking requirements can be sent back via the same network to ensure accurate and speedy restocking.

According to another embodiment, humans input data for products on display including their quality and their quantities using a microprocessor with a memory for the data input. After input, the data is processed, preferably by downloading the data to a central computer, to determine product displays as function of product placement and quantity. From this information, the central computer can produce a planogram of placement in quantity of the products. Optimally, the planogram modifies an initial planogram in response to the information obtained during the data inputting. Such modifications include increasing or decreasing shelf space for a given product based on actual interest in the product. Preferably, the input data comprises a graphical representation of an amount of allocated space for the product and product geometry. Preferably, the microprocessor and electronic memory are located in the handheld computer device, such as a personal digital assistant (PDA).

The data entered into the handheld computer device can be downloaded into a central computer or onto a network server. Furthermore, data collected in a central computer at a given store or location can be shared by a wide area network, such as the Internet, thereby providing access to regional or global data information.

Preferably, the steps of entering the audit information are repeated for each product category, resulting in a planogram for an entire store. In addition, the invention permits preparation of specific planograms for each store, rather than planograms for all stores in a given region which might fail to account for demographics and any particular location.

An additional advantage of the present system is that the data can be inputted during critical shopping times. Entering data during critical shopping time shows actual consumer interest in products, which may not be accurately reflected by end-of-day sales data or inventory.

In addition to generating planograms, the present method permits generating automatic product reorders as well as routine sales reports.

Furthermore, another advantage of the present system is that data input can be performed by in store sales clerks or by field representative operating independently. Indeed, because of the ability to collect data over local or wide area networks, an outside service provider can produce independent reports, planograms, and reorders based purely on the objective real time sales data particularly sales data generated at critical shopping times.

A system for optimizing a product display is also provided and includes a programmable microprocessor network, configured to receive input of data of products on display and quantity of specific products within a category of products; process the input data as a function of: the product geometry; the geometry of the display; and the amount of product that exists at the time of the snapshot; and produce a planogram which optimizes the geometry of the product within the display such that the amount of allocated space for the product is inversely proportional to the relative quantity of remaining product.

Also, provided is a system which includes a microprocessor device with memory adapted to receive input corresponding to a visual report of an amount of product in a product display in a business and store the data in the memory, and a central computer for receiving and processing the data from the microprocessor device so that the computer is configured to create a planogram which optimizes the display of the product whereby the computer maximizes the amount of desired product and minimizes the amount of undesired product to be displayed.

Plus, the exemplary system disclosed herein can form the backbone of a Perishable Item Management System (PIMS) which involves a multiple step program that includes implementing:

1. Stock Room Controls for:

(a) Ordering

(b) Variety

(c) Cold Chain

(d) Hygiene

(e) Stock Rotation

2. Planograms for:

(a) Shelf Management

(b) Product Presentation

3. Improving Communications between staff and managers from the store to area levels.

### BRIEF DESCRIPTION OF THE DRAWINGS

The above and still further objects, features and advantages of the present invention will become apparent upon consideration of the following detailed description of a specific embodiment thereof, especially when taken in conjunction with the accompanying drawings wherein like reference numerals in the various figures are utilized to designate like components, and wherein:

FIG. 1 discloses a general flow chart of an exemplary system for inventory control;

FIG. 2 discloses a detailed information flow diagram;

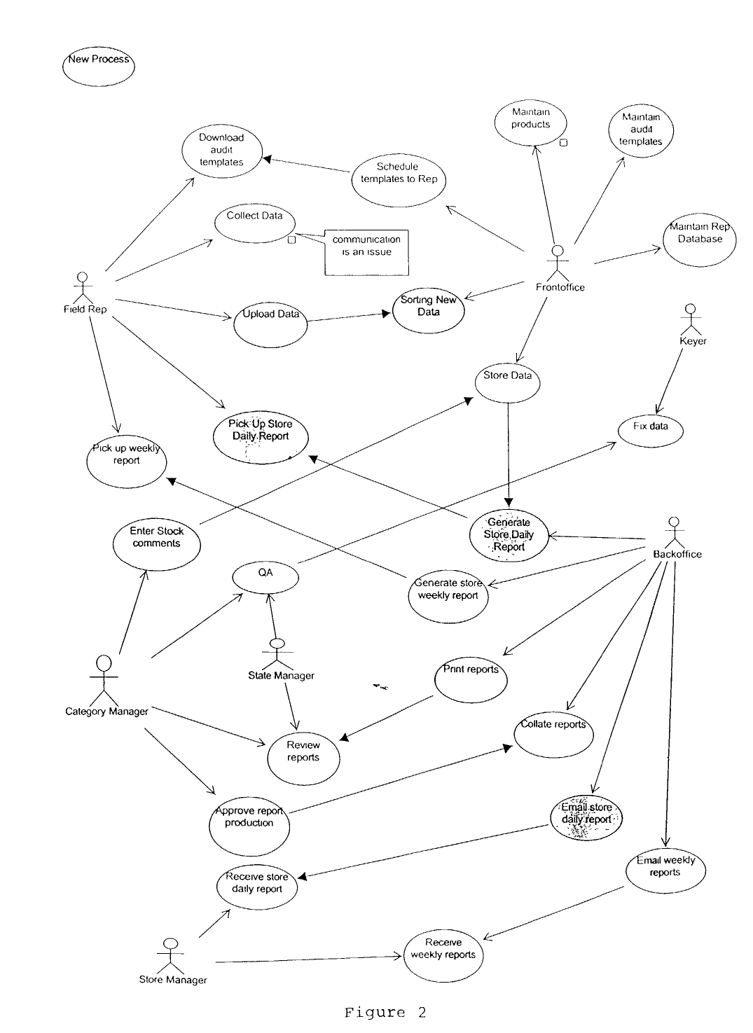

FIG. 3 discloses a detailed flow chart of the first stage of an exemplary system for inventory control;

FIG. 4 discloses a detailed flow chart of the second stage of an exemplary system for inventory control;

FIG. 5 discloses a detailed flow chart of the third stage of an exemplary system for inventory control;

FIG. 6 discloses an illustrative mode of another exemplary system for inventory control;

FIG. 7 discloses a detailed flow chart of Image Recognition system;

FIG. 8 discloses a flow diagram of the servers' actions; and

FIG. 9 discloses a flow diagram for ‘Route’ Management embodiment.

### DETAILED DESCRIPTION

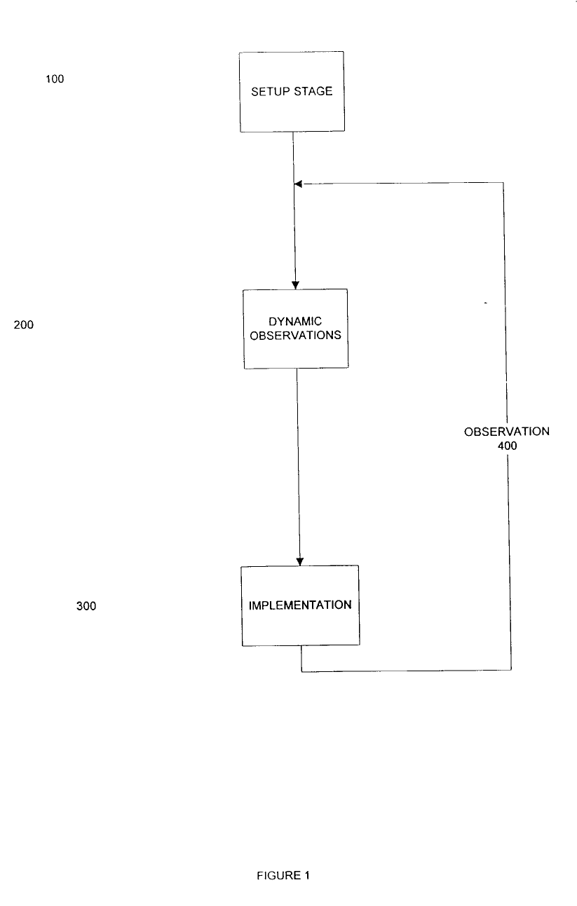

According to one preferred embodiment, a video imaging inventory management system is provided. This present embodiment automates a very large portion of inventory control and can place it in a centralized location. It also removes the need of personnel at every store location to take the required reports, thereby lowering costs and increasing efficiency. This system has a video camera trained on every aisle of merchandise. These video images are then fed, either through a Local Area Network (LAN) to a computer located in the store, or over a Wide Area Network (WAN) (e.g. the Internet) to any computer in the world. Once the images are sent to the computer it will process the information using real time image recognition software. The present application advantageously provides a method and system (see FIG. 1) for automating in store inventory control, planogram preparation, reordering, and sales performance. There are many advantages realized by the present system. The system eliminates the use of handwritten documents and personnel and the present system can be configured to control the ordering and delivery process. As opposed to other systems, the cost and disruption to install video cameras are minimal video camera technology is advanced so cameras can be very small and inexpensive. Additionally, the cameras will likely be ceiling mounted, thus removing the need to empty and refill the shelves to install the system. Also, the simplicity of installing the cameras will not disrupt the shoppers.

Any Management system, including a Perishable Item Management System, as described below entails a multiple step process:

Step one involves benchmarking the existing store by performing an audit and profiling the store's existing sales and making planograms (digital photographs that show the product's placement on the shelves) of the existing shelving layout of the products. The audit is done using a specific custom report designed for the specific item and compiled into a number of reports to aid in profiling the store's perishable item management. Using these reports, a new store layout and planograms are made for each store based on their existing layout. These reports are also compiled and presented to the store buyer and Area Manger for that store. Benchmarking allows a store to know exactly how much it sells of a particular product, how much it could have sold if it had more in stock, and how much waste it currently has due to product spoiling on the shelves or in the cold room.

One example of this system involves the management of a dairy case. In this instance, there is one specialized Store Audit Report that contains twenty (20) different factors that are crucial in measuring the efficiency of a dairy case. These key factors include temperature, adherence to whatever stocking model is being implimented, how the products are presented, hygiene, product rotation and inventory.

The second step involves the implementation of a new hygiene and stock order procedure. One such procedure that could be implemented is a ‘Ribbon’ system of shelving (see U.S. application Ser. No. 10/024,662). Another would be to just track the items, create the appropriate planograms and restock and shelf according to the new plan.

The third step is to make constant updates to the shelving model once it is in place. Then personnel will make random store visits and fill out an Audit Report. The store is called every second day for four (4) weeks to check on status and to troubleshoot any problems the store is having with the system. After the first four (4) weeks, stores that scored high in the rankings are left to self audit their own management system. Any stores still scoring low in the audits will be called daily until all of the problems are worked out.

This system can be implemented manually, using personnel and existing paper reports, updated to use a PDA or portable computer or can be automated using an Image Recognition Management System.

An example of this method can be used to develop a management system to control the dairy case. Here, hygiene and freshness are crucial elements to the profitability of the milk. Benchmarks are taken to understand the level of hygiene, stock rotation procedures, cold room storage space and ordering habits. Once the benchmarks are set, the employees can be trained in the new system of management (whether Ribbon or otherwise). The constant auditing for the first four (4) weeks is crucial to the success of the program. These audits are optimally performed by an outside employee, not an employee in the store being audited. The manager of the store is then contacted every second day and given assistance in the areas where the store scored low in the audits. Consistent low scores can result in retraining in the new system or in any specific problem areas. Four weeks usually allows ample time to work out any difficulty or problems any store is having. Next, after all the stores have been audited and called for four weeks, the next stage is to concentrate on the stores that are still having difficulty. The stores that are scoring high and can function without constant audits will be left to self audit. Those stores that still have difficulty with the new system will be concentrated on, with calls and Audits daily until they have removed all their problems.

While the present system has been described with particular reference to milk, system can improve sales efficiency of any perishable item, including but not limited to bread, vegetables, and meat.

According to the present method, the software is modified to identify the products on the particular shelf. It will draw from a database of known photos of products and use known image recognition technology to identify what product is missing from the shelf. That information can then be used to create orders to restock the shelves and/or create new planograms for stocking and product facing.

Once a new planogram is generated, it can be transmitted back to the store or any representative or manager using any form of existing or “next generation” cellular, wireless or PDA technology. Future technology will expand the speed and size of any data or image transmitted but will not change the way the system works.

This system can be used to develop stocking orders in real time and with a minimum amount of human processing in route deliveries. Cameras mounted in the stores can, using the software above, determine what each store needs and transmit that information to the distributer. Once this information is received, route stocking and delivery sheets could be generated allowing the trucks to be stocked with only what the customers need. Also, this allows the store who is last on the delivery route to always get what that store needs and not just what is left on the truck.

The present application advantageously provides a method and system (see FIG. 1) for automating in store inventory control, planogram preparation, reordering, and sales performance. There are many advantages provided by the present system. One of which is that it eliminates the use of handwritten documents by allowing an in-store product representative or field representative to enter audit information into a computer, particularly a personal digital assistant (“PDA”) such as a Palm Pilot™. The invention further increases efficiency by creating a graphical method for entering the data, thus simplifying the field representative's work requirements and permitting uniform reporting from store to store. The system permits downloading data from the individual computers, particularly PDAs, into a central server database, such as Microsoft AcceSS™ network or central computer is specially programmed to produce out-of-stock reports, trend graphs, store audit, planograms, and reorders. Database information can be automatically emailed to specified distribution list, which includes the store manager, category managers in the store, and regional managers.

As seen in FIG. 1, the present system/method consists of four main stages. In a first, or set-up stage 100, the system records information regarding the geometry of a display and the geometry of a category of products to be displayed.

Using data from set up stage 100, a field or store representative can audit product, e.g., input the amount of product per display in order to develop an initial planogram (described later). In a second, or dynamic observation stage 200, the system receives information regarding how much shelf space is used or unused during a peak sale period of a chosen day or a peak time period over a predetermined time period, such as a weekend. In this stage, the system can develop a new planogram as a result of the dynamic observation. The purpose of this new planogram is to optimize the amount of desired product and minimize the amount of undesired product kept at a given display. In the third, or implementation stage 300, the system calculates the required change in shipment delivery and contacts product suppliers to assure the proper implementation of the planogram scheme. The fourth, or observation stage 400, involves additional audits at predetermined periods of time to determine whether the system needs to update the planogram developed in the dynamic observation stage.

This arrangement creates an integrated system with the ability to manage inventory more powerfully and effectively than previously possible. The system preferably implements planning based on data gathered at critical shopping times by measuring stock on display, e.g., on a shelf. A “critical shopping time” is the time during the week, and during a given day of the week, when there is the greatest demand for a product. One of the advantages of the present system is that by simplifying and systematizing data collection, retailers can obtain this information as a snapshot of actual demand at the point of display, freeing them from reliance on inferential data collected through end of day inventorying or sales.

In accordance with the invention, data is not skewed by restocking, which understates interest in a product; overstocking certain items, which can lead to apparent brisk sales of the item based on totals; or other inventory permutations. By using computer processing and memory, the data is available and usable in time to implement inventory changes that are responsive to customer needs. In addition, because the system can employ a graphical interface for critical time inventorying, the data is consistent and does not require extensive effort to input. Because the system measures actual customer needs and wants, the store is better able to stock and sell products.

A “microprocessor with a memory” is any electronic device with input-output capability, including without limitation, a handheld device (also called a PDA), a personal computer (e.g., on a cart for mobility within a store if used for data collection or in an office for receiving downloaded data), or a network server.

The term “graphical representation” (or “visual shorthand”) refers to a symbolic input/output that represents the location and quantity of products on display in a store. Symbolic inputs include number codes, color codes, and symbol codes (e.g., as discussed below, using +, −, and 0).

The term “Image Recognition Software” is software that is currently developed to aid in facial recognition. The software is programmed with a database of known photos and compares the static photo to the facial image being sent over real time video. The computer will then recognize key features and compare it against the known database. This is patented technology, see U.S. Pat. No. 6,292,575 to Bortolussi et al., U.S. Pat. No. 6,301,370 to Steffens et al., and U.S. Pat. No. 5,164,992 to Turk et al., all of which are incorporated by reference in their entireties.

The term “geometry” as used herein refers to the shape of a product or shelf arrangement. Thus “product geometry” means the shape of the product. “Display geometry” means the arrangement of products in a display, such as shelf position and quantity.

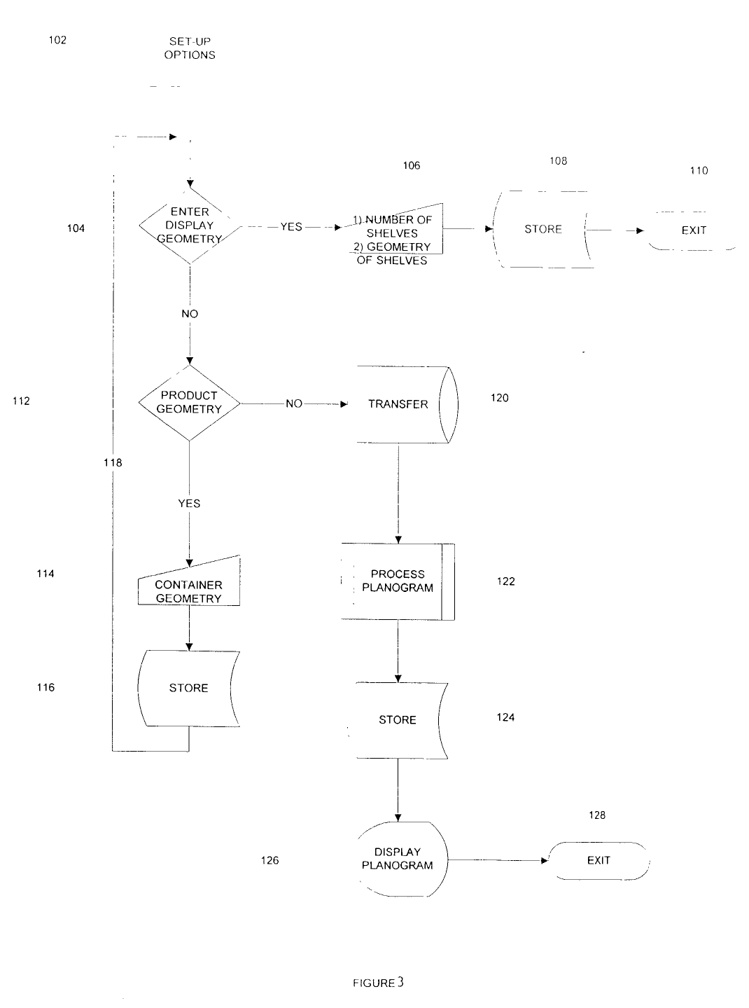

Turning now to FIG. 3, the set-up stage of the present system is defined in further detail. Initially a user engages the system on, for example, a hand held computer. An example of a hand held computer with an Operating System (OS) known in the art is a Palm Pilot™, although any handheld computer can be used, including others using the Palm OS. Through the handheld computer, the system provides set up options to the user (step 102). These set up options include allowing the user to affirmatively select between entering data concerning the display geometry (step 104) or entering data concerning the product geometry (step 112). Once the user selects one of these options, a flag is set. The system then sequences through the possibilities to determine which flag has been set. Assuming the user has selected to enter data concerning the display geometry, the flag for that option would be “Yes”. Furthermore, the flag for product geometry is “No”.

As a result of the user selecting the option to enter display geometry, the system branches into a display input screen (step 106). This screen presents the user with input fields for inputting a number of shelves in the display and the depth and height of each shelf within the display. Alternately, this information can be pre-set in the hand held computer. Once the user has entered the information into the fields, the system allows the user to save the entries into memory of the hand held computer (step 108) by, for example, hitting an “enter” key. The system then exits the current screen (step 110) and provides the setup options to the user.

After entering the geometry of the shelves, the system is manipulated by the user so that a flag is set for “Yes” for entering data concerning product geometry (step 112). As a result, no flag is set for entering data for display geometry. The system then branches to a screen for inputting data corresponding to container geometry (step 114). For example, the user can input data reflecting a standard geometry for a carton of milk, being a half gallon or a pint. Since most products have standard shapes based on size, product geometry can be preset in the hand held computer. Alternatively, the user inputs an exact geometry accounting for the cross sectional area of the container and the height of the container as well as other relevant radial or square dimensions of the container.

Based either on pre-set or entered geometry data, the handheld computer can generate a graphical schematic screen for entering inventory data. In this graphical system, a data entry clerk, e.g., field representative, can input inventory information symbolically, using for example, +, −, 0, and other symbols to indicate full stock, depleted stock, out of stock, etc.

Once the user has entered the information into these fields, the system allows for the storing of this information on the hand held computer (step 116) by, for example, hitting an “enter” key. After the storing of the container geometry for the product is complete, the system allows the user to again either enter data concerning the display or data concerning the product geometry (step 118).

After completing the entry of the various container geometries and display geometries for a given category of product, neither option for display geometry nor product geometry are flagged. As shown in FIG. 3, the system transfers the stored data from the hand held computer to a processing system on another computer, for example, located in the store (step 120). The two local computers can communicate with each other via wireless Local Area Network (LAN) connections, and individual computers or LANs that communicate via Wide Area Networks (WAN), such as the Internet, as is well known in the art.

Once the systems have transferred the data, the receiving computer processes the data (step 122), accounting for the category of product, the physical limitations of the product and display that were input in the previous steps. The system stores this processed data (step 124) and provides the data in the form of an initial planogram (step 126), known in the art, for the purpose of an initial display of the product category within the physical display configuration. The category itself is a factor because, for example, people may be more likely to purchase certain categories of products when located at eye level, while preferentially purchasing other items located at a lower level. Moreover, people may purchase some category of products more frequently in smaller quantities, but other categories in larger quantities. This information is known in the art and thus readily accessible by the system whereby the system accounts for these preferences when developing the initial planogram. Once the initial planogram is provided to the user, the system terminates the current process (step 128).

The planogram developed here is essentially a three dimensional array. The array has a row position, which is a horizontal position on the display. The array also has a column position, which in a vertical position on display. Identifying the row and column position brings a user to the forward-most position of a product within a display array. The array also has a third variable, depth (or quantity) of product within the display array. The three dimensional array provides information about all products within a category, as well as how a category of products is to be displayed. Planograms are well known in the inventory management art. However, the programs that generate planograms are self contained systems, requiring human intervention to input and output data and analyze the results. The current system automates a majority of the process to increase inventory control and reduces costs.

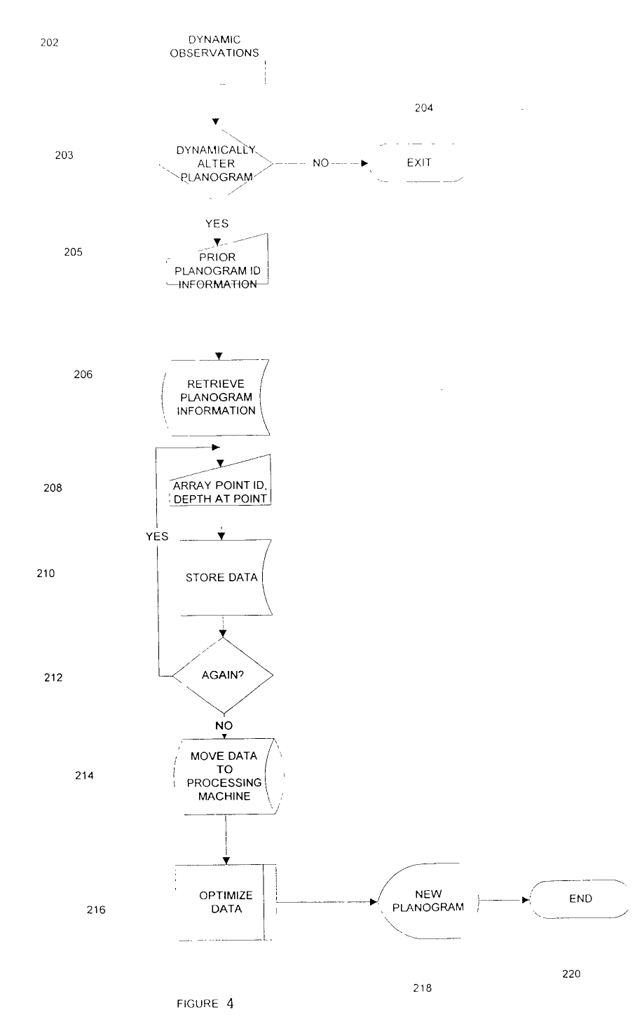

Turning now to FIG. 4, we see a detailed illustration of dynamic observation stage 200 of the present invention. The system allows the user operating the hand held computer to affirmatively choose to dynamically alter the stored planogram based on actual observations (step 203). The user could choose to flag “No” to exit the system (step 204). Assume the user flags “Yes”. The system cycles through the options, discerns the “Yes” flag, and branches to a screen with input fields for identifying the relevant planogram stored on the processing computer (step 205). For example, the relevant planogram can be identified by business name and location, and by product category. Effectively, the display fields reference the planogram developed at the end of the setup stage. Hitting the “enter” key allows the system to process the information input by the user. The system then retrieves the planogram and relevant data (step 206) by communicating with the memory of the distant processing computer, as described above.

Once the system causes the hand held computer to retrieve the relevant planogram, the system progresses to a data input screen (step 208). The data input screen allows the user to identify the row and column of a product so that a particular array location can be found on the original planogram. The input fields allow the user to enter the graphical data or, alternatively, enter how many products are at the particular array location (the depth variable of the array). The system stores this information after the user engages the enter key (step 210).

In the next step, the system progresses to a screen which allows the user to affirmatively chose whether or not another array location is to be audited (step 212). Unless all positions on the array have been updated, assume that the user flags “Yes” to this question. The program sequences through the possibilities to determine whether the flag is “Yes” or “No”. When the flag is “Yes”, the system returns the previous step prompting the user to identify an array location by row and column and then enter products data for that display location.

Once the user has entered all of the information into the hand held computer pertaining to the display, the user flags “No”. The system then transports all of the new data to the processing computer (step 214). The processing computer optimizes the display to generate a new planogram (step 216). The factors that the processing computer considers include whether the display was overstocked on a product, or under stocked on a product and, and the geometry of both the product and the display. For example, if a product has not sold at all, then the processing computer realizes that this product is overstocked and will produce a planogram with reduced display space for this product. If a product is under stocked then the processing computer increases display space for that product on the planogram.

The system next progresses to displaying and printing the updated planogram for the user (step 218). After the system has generated a new planogram, the system stores the information pertaining to a new planogram onto the processing computer and the system is exited (step 220).

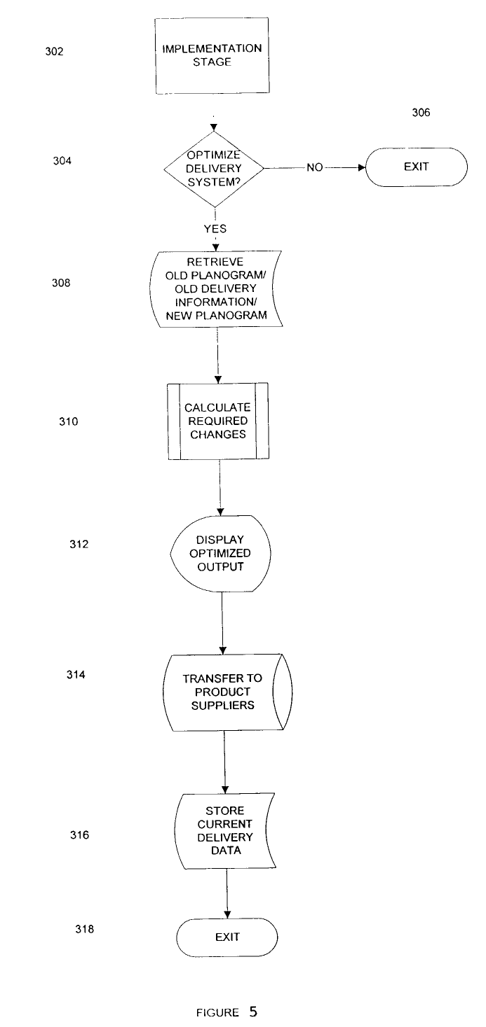

Turning now to FIG. 5, we see a more detailed illustration of implementation stage 300 of the present invention. In the initial step of this stage, the system allows the user of the processing computer to affirmatively select to optimize the actual delivery capacity for the store based on the newly developed planogram (step 304). Once the user flags “Yes” or “No”, the program sequences through the possibilities to determine which flag has been set.

Assuming the user of the processing computer chooses to optimize the actual delivery capacity, the system retrieves the planogram stored in internal memory that existed prior to the just developed planogram, as well as the delivery capacities related to the prior planogram. The processing system also retrieves the new planogram stored on internal memory. Once the system has retrieved the required information, the processing computer of the system then calculates the change in delivery capacity to meet the requirements of the new planogram (step 310). The calculated change is a function of storage capacity of the display (short term storage) and business (long term storage) as well as the shelf life of the associated goods. It is to be appreciated that goods such as milk and fresh produce have a relatively short storage life as compared to goods such as canned foods. Thus, milk delivery is less a function of long term storage and more a function of display space. Canned goods, however, may be stored for a greater period of time. Thus, more rapid delivery of canned goods is not as much of an issue as compared to milk.

The system transfers the results of the optimized output to the vendors that the business has contracted with for the purpose of supplying the various quantities of product (step 314). The processing computer communicates with computers located at the suppliers analogously to how the processing computer communicates with the hand held computers used by the system of the invention. Once the processing computer learns that the computers of the suppliers have received the new requirements data, the system stores the new delivery requirements (step 316) on the processing computer and the system is then exited (step 315). The storage of these delivery requirements enables future adjustment of these requirements as needed.

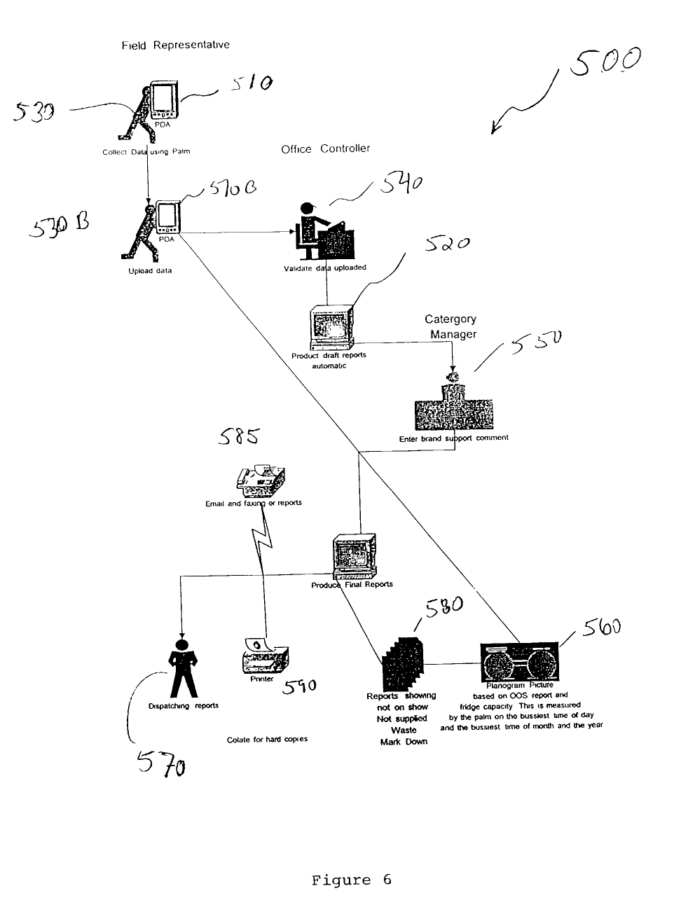

In one mode of operation, shown in FIG. 6, the store with the products that requires the service is a different organization than the business that renders the services 500 and owns the hand held computers 510 and the processing computer 520. The hand held computer 510 is operated by a Field Representative 530. The Field Representative 530 is employed by the service provider 500 because the store employee may have motivations to incorrectly enter data into the hand held computer 510 to enhance job performance appearance, or because of a bias towards or against the sale of certain brands or sizes of goods.

Assume that the store owner is seeking to generate a planogram for a chosen category. In the first stage of the invention, illustrated in FIG. 6, the Field Representative 530 enters the required geometric data into the hand held computer 510 (described above). When the Field Representative 530 has entered all the required data, the hand held computer 510 transfers the data to processing computer 520 of the service provider 500.

Once the processing computer 520 receives the data, it compares the data with category information entered by a Category Manager 550. As indicated, the Category Manager 550 enters category data required for the system to produce the initial planogram 560 (described above). An Office Controller 540 reviews the planogram 560 and delivers it to a Report Dispatcher 570. The Report Dispatcher 570 delivers the planogram 560 to the store owner for initial display implementation.

In the second phase of the present system, the Field Representative 530B uploads the initial planogram information into the hand held computer 510B and enters dynamically observed data (described above). Once the Field Representative 530B has entered dynamically observed data, the system transfers the data from the hand held computer 510B to the processing computer 520. The processing computer 520 generates the optimized planogram that differs from the initial planogram 560 as a result of overstocking or understocking of products (described above). The optimized planogram is delivered by the Office Controller 540 to the Report Dispatcher 570. The Report Dispatcher 570 delivers the optimized planogram to the store manager for implementation purposes.

In the third phase of the present system the Office Manager 540 causes the system to contact the computers operated by the product suppliers (described above). The information is transferred in the form of reports 580. As indicated, the reports 580 relate to the new delivery requirements calculated from comparing the new planogram with the initial planogram. Although this communication preferably occurs over the Internet, it will be understood that this communication can equally occur via facsimile 580 as a result of printouts 590 generated by the Office Controller 540 and passed to the Report Dispatcher 570 or any other means suitable for the intended purpose.

The above process is repeated during a peak sales period of each day (or at a set time during a pre-set period) for each category of foods within a business. It is to be appreciated that if milk is analyzed on a given day then in the next analysis period, the category of cereals can be analyzed, followed by the category of canned goods, followed by the category of cheeses or yogurt or ice creams, etc. This process is repeated for every category of goods within a store until a planogram is developed for every category of goods and a related delivery scheme is developed for every category of product within a store.

This entire process is repeated for every single store in a given food chain so that each store in a food chain has an individual planogram for every category of food. As a result, the display of each category of food within each individual store is automatically optimized and designed around that the requirements of that store.

The process described herein solves many problems of the prior art because while the prior art only exhausted daily customer consumption, the present process determines the peak requirements of customers. Further, the process of the prior art only considered averages of stores within a chain. However, the present process permits determination of specific requirements of each store within a chain of stores. The present system therefore allows for an optimized amount of sale and display of desired goods as well as an optimized amount of sale and display of relatively undesired good, so that each store can achieve its maximum potential of sales for every category of goods. Moreover, the system assures that delivery of goods will be optimized so that stores, and therefore customers receive the required goods at the required times.

It is to be appreciated that the above process can be repeated for various seasons when such goods require this repetition. For example, fresh fruits and vegetables are replaced each day, allowing implementation of a new planogram on a daily basis, whereas dry goods such as pasta, canned food, cereals, and the like can be re-planned quarterly. Thus, restocking and implementing a new planogram can accommodate the normal labor practices of a store. Further, weekday sales might peak differently from weekend sales, necessitating repetition of the process on a per week and a per weekend basis. It is to be appreciated that the more often the process of the present invention is repeated, the less susceptible the process is to error or a typical fluctuations in a common market.

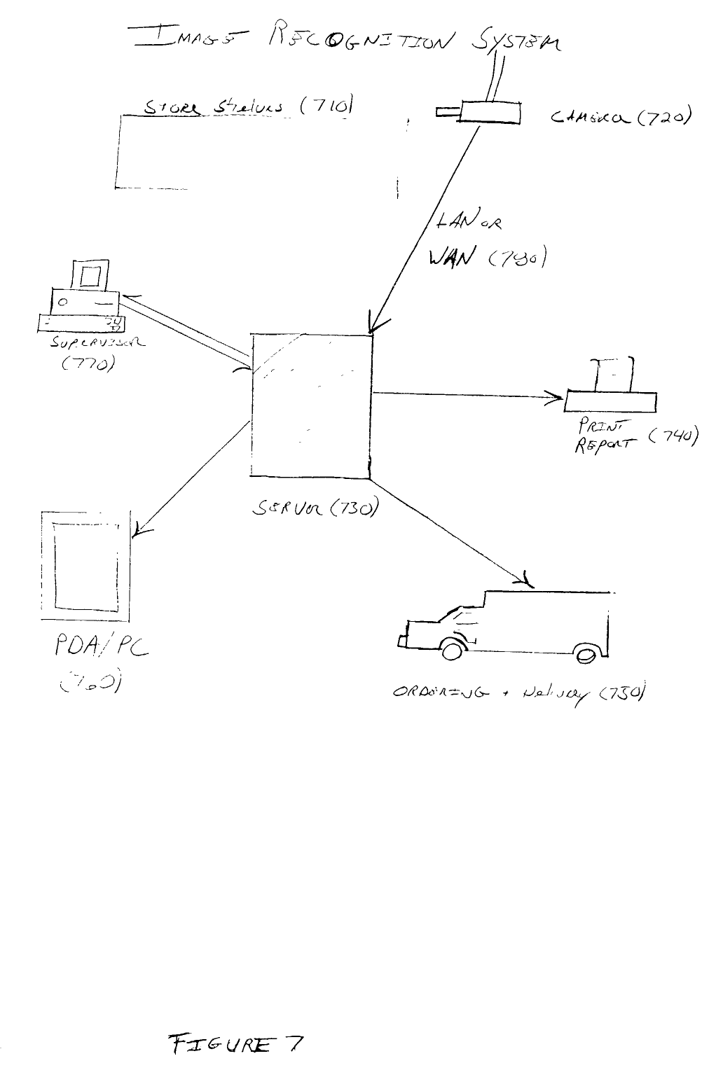

As seen in FIG. 7, an Image Recognition Inventory Management system works differently. Here, the items are placed on the store shelves in a predetermined location 710. Next, a camera 720 is installed facing the shelves and has the entire shelf under surveillance. The camera can be hard wired or wireless. Camera 720 receives an image of the shelf and this image is continuously being transmitted over a network 780 (e.g. LAN or WAN) to a server 730 for constant updates. Software then determine, in real time, when items drop below a threshold value or go out of stock. A supervisor 770 can be notified of the condition and make manual changes to any of the below processes. Once the system takes notice of a missing product, it can check the inventory of the store and see if it can be pulled out of storage. If the product is not in stock, it can set up an order and delivery 750 of the goods needed. The system can determine the identity and quantity of the goods that are needed. Depending on the inventory and availability of any product, the server may adjust the planogram to take the day's sales into account. Once a new planogram is created, the system can print a report for the office 740. Also, using existing and next generation wireless and cellular technology, the system can transmit an updated copy of the planogram to a PDA/PC 760 of any store manager to show them the stocking changes.

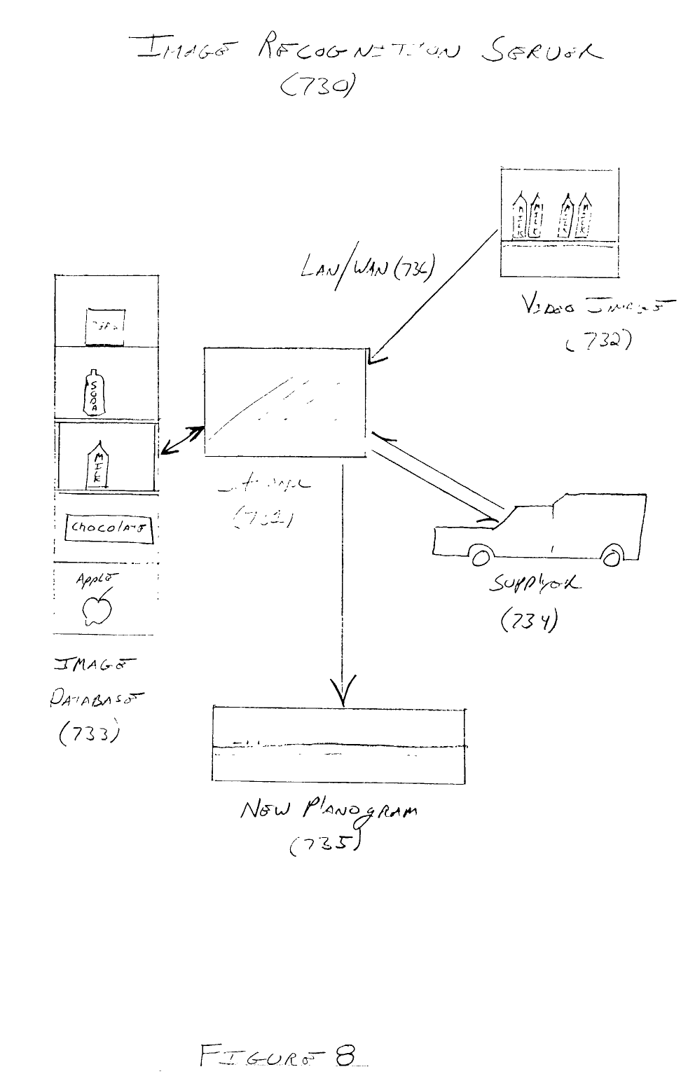

FIG. 8 shows the process by which the server updates the planogram. First the server 731 is receiving real time video 732 from the camera in the store over a LAN/WAN 736. Software loaded on the server takes the present image and continuously compares it against its image database 733 to see if a product is missing. Once the software determines that there is a product missing, it determines the identity of the missing products. The software then communicates an order for the appropriate quantity of the missing product to a supplier 734 and using the information the system has gathered on the amount of product that has been sold and what is being delivered, it will update the planogram 735 to accommodate the new change. The program will also keep track of items that do not sell and take that into account when allocating shelf ‘real estate’.

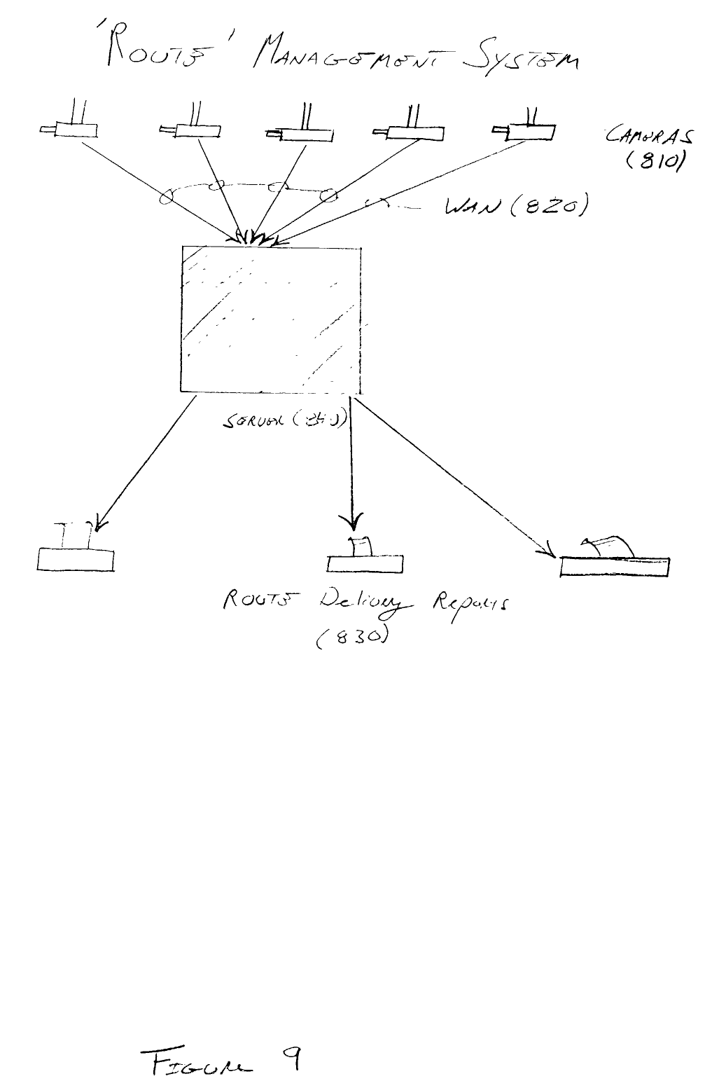

The Route Management embodiment is shown in FIG. 9. Here, cameras 810 set in multiple stores will relay their real time video to a server 840 over a WAN 820, like the Internet. Here, server 840 uses image recognition software to determine what goods are sold out of any particular store on any one day. Server 640 then compiles a list of all the goods that are out of stock and prepare route delivery reports 830. These reports are generated for each individual route for each truck to stock only what his customers need and thus every store along the route, regardless of whether the store is first or last, will get exactly what they need for the following day.

While the invention has been described with particular reference to groceries, the approach of the invention can improve sales efficiency of any retail product, including but not limited to stationary and office supplies, clothing, sporting goods, pet products, hardware and home products, linens, etc.

The present invention is not to be limited in scope by the specific embodiments described herein. Indeed, various modifications of the invention in addition to those described herein will become apparent to those skilled in the art from the foregoing description and the accompanying figures. Such modifications are intended to fall within the scope of the appended claims.

Reference citations, patents and patent applications, and product descriptions and protocols are cited throughout this application, the disclosures of which are incorporated herein by reference in their entireties for all purposes.

1. A method of generating a product display planogram, which method comprises the steps of:
(a) inputting data associated with a group of products on display and quantity of specific products within a category of products into a microprocessor with an electronic memory;
(b) processing the inputted data to create an image representation to determine a product display as a function of product placement and quantity; and
(c) producing a planogram showing the product placement and the quantity of the product.

2. The method of claim 1, further comprising the steps of:
analyzing the inputted data and a product inventory to determine the quantity of the product remaining; and
ordering the product when quantity of the product remaining reaches a predetermined value.

3. The method of claim 1, further comprising the steps of:
analyzing the inputted data to determine a peak purchase time and a quantity of the product sold during the peak purchase time; and
ordering the product to arrive prior to the peak purchase time; and
ordering a sufficient quantity of the product to satisfy the quantity of product sold at the peak purchase time.

4. The method of claim 1, wherein the inputted data comprises a graphical representation of an amount of allocated space for the product.

5. The method of claim 1, wherein the microprocessor and the electronic memory are located in a handheld computer device.

6. The method of claim 5, further comprising the steps of:
downloading the image representation from the handheld computer device into a central computer.

7. The method of claim 1, further comprising the steps of: repeating the steps for each of the product displays to create the planogram of each of the product displays in a store.

8. The method of claim 7, further comprising the steps of:
repeating the all above steps for the store within a chain of the stores so that each of the stores can develop a unique planogram.

9. The method of claim 1, wherein the data is inputted during a peak purchase time.

10. The method of claim 1, further comprising the steps of: generating a product reorder.

11. The method of claim 1, wherein the data is inputted by an independent field representative.

12. A system for optimizing a product display comprising:
a programmable microprocessor network, the programmable microprocessor network being configured to receive data of a product on a product display and a quantity of specific products within a category of the products, process the data as a function of a product geometry, a display geometry, and the amount of the product that exists at the time the data is entered into the programmable microprocessor network; and
a microprocessor connected to the programmable microprocessor network and producing a planogram to optimize the display geometry such that the amount of allocated space for the product is inversely proportional to the relative quantity of remaining product.

13. The system of claim 12, wherein the product geometry is the size, shape and preferred facing of the product.

14. The system of claim 12, wherein the display geometry is the arrangement, shelf position and quantity of each product on a shelf.

15. The system of claim 12, further comprising: a communication device connected to the programmable microprocessor network to receive product quantity information and communicate to a supplier to order the product.

16. A system comprising:
a microprocessor device including:
an electronic memory adapted to receive and store an input of data corresponding to a visual report of an amount of a product in a product display in a store a; and
a central computer for receiving and processing the data from the microprocessor device with the central computer being configured to create a planogram which optimizes the product display of the product, whereby the central computer maximizes the amount of desired product and minimizes the amount of undesired product to be displayed.

17. A method of managing inventory comprising the steps of:
recording an image of a shelf having of a plurality of products stored thereon;
using an image recognition system to identify each product and a location of each product; and
creating a planogram using the identity and the location of each product.

18. The method of claim 17, further comprising an image recognition database stored in a central computer, the image recognition database including a plurality of images of all the products contained in a store.

19. The method of claim 18, further comprising a video camera installed in the store such that it has a constant view of the shelf, the video camera being linked to a central computer over a Local Area Network (LAN) or a Wide Area Network (WAN).

20. The method of claim 19, further comprising the step of transmitting real time images of the shelf over the LAN or WAN to the central computer.

21. The method of claim 18, further comprising the steps of detecting and distinguishing between different products on the shelf by accessing the image recognition database and comparing the real time image to the images stored in the image recognition database

22. The method of claim 21, wherein image recognition software is on the central computer and detecting and distinguishing between the different products on the shelf by referring to the image recognition database.

23. The method of claim 18, further comprising the step of communicating over the LAN/WAN to a supplier who supplies the products to the store to order more product.

24. The method of claim 22, further comprising the step of detecting if one product is out of stock on the shelves using the image recognition software on the central computer.

25. The method of claim 23, wherein the central computer contacts the supplier over the LAN/WAN when one product is detected as being out of stock and places an order for an additional amount of replacement product to be delivered.

26. The method of claim 21, further comprising the step of updating the planogram using information the central computer receives from the image recognition software and the supplier.

27. The method of claim 26, further comprising the step of printing the new planogram on a printer.

28. The method of claim 23, further comprising the step of wirelessly communicating product information with the central computer using a microprocessor and an electronic memory.

29. The method of claim 24, wherein the central computer transmits the new planogram to the microprocessor to be stored in the electronic memory.

30. A system for optimizing stocking and delivery of items sold to a store on a ‘route’ delivery system comprising:
a central computer;
an order report generated by the central computer when the central computer detects the missing products on the shelf, the central computer storing a running total of every the product that is out of stock, and the central computer compiling the totals into the order report.

31. The system of claim 30, further comprising an image recognition database stored in the central computer, the image recognition database is comprised of images of all products in every store.

32. The system of claim 31, further comprising a video camera installed in each of the stores, the video camera has a constant view of a stocked shelf, the video camera is linked to the central computer over a Wide Area Network (WAN).

33. The system of claim 32, wherein the video camera is transmitting real time images of the shelf over the WAN to the central computer.

34. The system of claim 32, further comprising image recognition software running on the central computer, and configured to detect and distinguish between different types of the products on the shelf by accessing the image recognition database and comparing the real time image to images stored in the image recognition database.

35. A method of managing perishable products, comprising the steps of:
benchmarking a current managing procedure;
implementing a new managing procedure; and
auditing to determine compliance with the new managing procedure.

36. The method of claim 35, wherein the benchmarking procedure comprises the step of compiling a list of factors crucial to the proper management of the perishable products.

37. The method of claim 36, wherein the factors include hygiene, product rotation, cold room facilities, temperature, light and product exposure.

38. The method of claim 37, wherein the hygiene is the cleanliness of the perishable product and the cleanliness of a product display, the product display comprising a shelf or group of shelves where the perishable products are displayed.

39. The method of claim 38, wherein the product rotation comprises the steps of:
rotating the perishable product to be stocked on the product display so the perishable product having the closest expiration date to the current date is always in the front of the product display; and
removing the perishable products that have expired from the product display.

40. The method of claim 39, further comprising the step of keeping a cold room facility at a specific temperature depending on the nature of the perishable item.

41. The method of claim 39, wherein the product exposure is how and where the perishable product is placed on the product display.

42. The method of claim 35, further comprising an audit sheet, the audit sheet comprising a list of factors, wherein each factor comprises a corresponding point score that varies with the degree of compliance with the list of factors.

43. The method of claim 35, further comprises the step of performing an audit prior to implementing the new managing procedure, a minimum time for the benchmark audit is one (1) week prior to implementing the new management procedure.

44. The method of claim 37, wherein the new management procedure comprises changes to one or more of the list of factors.

45. The method of claim 41, further comprising the step of randomly auditing the new managing system, the random audit is performed a minimum of once a day for four (4) weeks after the new managing system has been implemented.

46. The method of claim 42, wherein the random audit uses the same the list of factors used in the benchmark audit, the random audit preformed by an independent employee not affiliated with the store.

47. The method of claim 46, wherein the audit sheet is displayed on a microprocessor with electronic memory.

48. The method of claim 46, further comprising the step of tallying a total point score from the audit sheet.

49. The method of claim 48, further comprising the steps of:
reviewing the tally sheets; and
contacting the store on every second day with the total point score.

50. The method of claim 49, further comprising the step of assisting the store with any of the factors the store scored low on.

51. The method of claim 47, further comprising the step of auditing only the stores that continually receive low point scores the audit sheets.

52. The method of claim 49, further comprising the step of daily contacting the store with the point score from the tally sheet; and
offering to help the store improve the factors.

53. The method of claim 49, further comprising the step of continually auditing the store receiving the low point score on the audit sheets.
